(19) United States
(12) Patent Application Publication
(10) Pub. No.: US 2009/0307960 A1
(43) Pub. Date: Dec. 17, 2009

(54) HOLLOW BAIT AND METHOD OF MAKING THE SAME

(75) Inventors: Francis J. Oelerich, Jr., Eufaula, AL (US); Michael E. McPherson, Eufaula, AL (US); Stanley B. Tyler, Eufaula, AL (US)

Correspondence Address: MOORE & VAN ALLEN PLLC, P.O. BOX 13706, Research Triangle Park, NC, 27709, US

(73) Assignee: Mann's Bait Company, Inc., Eufaula, AL (US)

(21) Appl. No.: 12/140,802

(22) Filed: Jun. 17, 2008

(51) Int. Cl. A01K 85/00

(52) U.S. Cl. 43/42.24; 43/42.35; 43/42.39; 43/42.47; 43/42.1

(57) ABSTRACT

The present invention provides a fishing lure comprising a body and a lip. The body includes a front end and a back end. The lip extends from the front end of the body and has a hollow interior portion. The lure is versatile due to its ability to effectively function as a “surface lure”, “wake bait”, and “crankbait” in a single cast.

### BACKGROUND OF THE INVENTION

1. Field of the Invention

The invention generally relates to fishing lures, and more particularly, embodiments of the present invention relate to fishing lures having a hollow lip.

2. Description of Related Art

Fishermen and manufacturers of fishing lures have found solid diving fishing lures advantageous to attracting and catching fish. Such lures typically include a hard plastic or metal diving lip that allows the lure to dive underneath the water while the fisherman cranks the lure, placing the lure in the strike zone of various fish underwater. Lures with a hard plastic lip are typically constructed by a process of injecting resin into a mold and hardening the resin to create a solid body with the diving lip extending forwardly from the lure body. Metal diving lips are typically mechanically attached to the lure body using fasteners.

However, using solid fishing lures has drawbacks. The solid lures are not only heavy but may become hung-up when the lure encounters an obstacle, such as vegetation, brush, fallen timber and the like. In this regard, the hooks attached to a solid fishing lure are typically attached to a protrusion extending from the lure body so that the hook is exposed. Thus, it can be difficult to use lures such as a crankbait or wake bait when casting near shore or other structures extending above the surface of the water or right below the surface of the water.

Accordingly, there remains a need for an improved fishing lure that is able to travel through obstacles without becoming snagged or hung-up on an obstacle, while yet still be able to dive to a desired water depth or area and to function as a combination crankbait, wake bait, and a surface lure. Such a lure should be fairly lightweight and have increased buoyancy, while still provide for level flotation and the ability to provide dive characteristics when being retrieved in open water.

### BRIEF SUMMARY OF THE INVENTION

The present invention addresses the above needs and achieves other advantages by providing a fishing lure having a body and a lip. The body has a front end and a back end and the lip extends from the front end of the body and is hollow. In one embodiment, the lip extends forwardly toward the front end of the lure body. In another embodiment, the lip extends from the bottom side of the lure body.

In one embodiment, the fishing lure body and the fishing lure lip are chemically bonded together so that the lip and the body are one integral piece. In another embodiment, the fishing lure body and lip may be two separate pieces joined mechanically together.

In one embodiment, the fishing lure body has a hollow interior. In another embodiment, the hollow interior of the fishing lure body and the hollow lip may be combined so that the fishing lure has one interior hollow area.

In one embodiment, the fishing lure includes at least one fish hook that extends at least partially through the body. In another embodiment, the fishing lure may include two fishing hooks attached thereto.

The fishing lure may be constructed of various materials, have various configurations and include various fish attracting elements. For example, in one embodiment, the fishing lure is constructed from an elastomeric material. In another exemplary embodiment, the fishing lure may include at least one fish attracting element or material, such as metal flakes. The fishing lure may include other modifications. For example, in one embodiment, the fishing lure includes at least one weight. Also, in another exemplary embodiment, an add-on item, such as a tail, appendage or a fish attracting element (e.g., a light emitting or sound creating element), may be connected to the back end of the fishing lure body. Various shapes and configurations of the fishing lure are possible. In one embodiment, the fishing lure has a configuration of a common bait species, such as a frog, worm, grub, snake, eel, fish, salamander, squid, shrimp, crab, small rodent, bird or other mammal.

According to another embodiment of the present invention, a method for forming a fishing lure includes forming a fishing lure using rotational molding. The resulting fishing lure includes a body and a lip. The body has a hollow interior and the lip extends from the front end of the body and also has a hollow interior.

The polymeric material that is employed may be of any form. For example, in one embodiment, the polymeric material inserted into the mold may be in a solid form, such as powder or pellet form.

The rotational molding may include various steps. For example, in one embodiment, at least one polymeric material may be inserted into a mold having a predetermined configuration. At least a portion of the polymeric material is contacted to at least a portion of the mold and the mold is rotated about at least one axis so that the polymeric material is allowed to coat at least a portion of an interior surface of the mold. This forms the sidewalls of the fishing lure. Thereafter, the fishing lure is removed from the mold. In another embodiment, prior to contacting the polymeric material to the mold, the mold is heated so that the polymeric material is allowed to absorb thermal energy and adhere to the sidewall of the mold. Also, after rotating the mold, the mold is cooled so as to cool the polymeric material. Heating may occur via conduction, convection or radiation processes.

Resulting from the rotational molding method is a fishing lure which includes at least a body and a hollow lip. Several configurations of the fishing lure are possible. For example, in one embodiment, the method may form the fishing lure in the configuration of a frog, worm, grub, snake, eel, fish, salamander, squid, shrimp, crab, small rodent, bird or other mammal. In one embodiment, the mold used to form the fishing lure has a configuration such that the lip extends forwardly from the front end of the body.

After the fishing lure is formed, other steps may be taken. For example, in one embodiment at least one fish hook may be attached to the fishing lure body. In another embodiment, two fishing hooks may be attached to the fishing lure body. In one embodiment, the hooks are at least partially concealed.

According to another embodiment of the present invention, a method for forming a fishing lure includes forming a fishing lure using dip molding. The resulting fishing lure includes a body and a lip. The body and lip each have a hollow interiors and the lip extends from the front end of the body.

In one embodiment, the dip molding process includes providing a mandrel. At least a portion of the mandrel is coated with at least one plastisol for a predetermined time. The coating step may include dipping the mandrel in the plastisol. The plastisol forms the fishing lure on the mandrel via a catalyzation process. The fishing lure is then removed from the mandrel. In another embodiment, prior to coating the mandrel with the plastisol, at least one lubricant, such as silicon oil, is applied to the mandrel. In still yet another embodiment, the mandrel may be heated. For example, using a convection oven or radiant heat, the mandrel is heated to at least 320° F. In one embodiment, the mandrel is heated between about 380° F. to about 400° F. In yet another embodiment, the fishing lure and mandrel may be cooled.

The mandrel may have various shapes and configurations. For example, in one embodiment, the mandrel may be configured so that a hollow lip is formed to extend forwardly to the front end of the fishing lure body. Also, in another embodiment, the mandrel may have a configuration similar to that of a frog, worm, grub, snake, eel, fish, salamander, squid, shrimp, crab, small rodent, bird or other mammal, where the mandrel forms a hollow lip in each of these configurations.

After the fishing lure is formed, several other steps may be undertaken. For example, at least one fish hook may be attached to the fishing lure. In another embodiment, two hooks are attached to the fishing lure. In one embodiment, the hooks are at least partially concealed.

In yet another embodiment, a decorative plastisol, such as eyes or pupils, is applied to the fishing lure and thermal energy or heat is applied to the decorative plastisol so that the decorative plastisol cures and adheres to the fishing lure.

The present invention has several advantages. The fishing lure of the present invention can be configured to emulate many common live-bait species and can be weighted to provide castability. More importantly though, the lure is versatile due to its ability to effectively function as a “surface lure”, a “wake bait”, and a “crankbait” in a single cast. More specifically, the fishing lure of the present invention is able to function as a surface lure immediately after the cast (i.e., floating on the surface of the water), which is typically near shore or adjacent other structures that are partially submerged and partially exposed (such as tree limbs, vegetation, brush or floating debris), which minimizes the possibility the lure will become snagged or hung-up. Specifically, the lure body and the lure lip are flexible so that when the lure encounters an obstacle, such as floating vegetation, brush, or fallen timber, the lure flexes rearwardly so that the lure may continue unimpeded. The fishing lure of the present invention is able to function as a wake bait (i.e., submerged just under the surface of the water) when retrieved at slower speeds to thereby create a large bulging wake imitating the motion of a small mammal swimming on the surface. The fishing lure of the present invention is also able to function as a crankbait during moderate to high retrieval of the lure (i.e., diving under the surface of the water) so that the lure can be placed in the strike zone of a fish during retrieval in deeper water. The high buoyancy to weight ratio of the fishing lures of the present invention also enable the lures of the present invention to provide life-like motion whether on and below the surface of the water. The functionality of the lure results from the lip and lure body being hollow, which provides for a reduction in weight, a higher buoyancy, more level flotation, and high castability.

The flexibility of the lip also allows the lure to remain in one area longer when the angler snaps the rod than a conventional surface lure having a solid lip. In this regard, the lip of the present invention has improved flexibility so that the lip initially deforms rearwardly in response to the force of the water thereby lessening the flow of water over the surface of the lip relative to a conventional solid lip. Thereafter, as the water begins to flow over the surface of the lip, the lip springs back into place due to the elasticity of the lip. This movement of the lip thrusts water forward, restricting the typical forward motion commonly associated with lures having solid lips.

The method of constructing the fishing lure of the present invention also has several advantages. In particular, the fishing lure is cost effective because less material is required to construct the lure and the method forms an integral lure without requiring additional adhesives or fasteners.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 is a perspective view illustrating a fishing lure having a hollow diving lip, according to one embodiment of the present invention;

FIG. 2 is side view of the fishing lure illustrated in FIG. 1A; and

FIG. 3 is a partial cross-sectional view the fishing lure in FIG. 1B taken along line 3-3.

### DETAILED DESCRIPTION OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

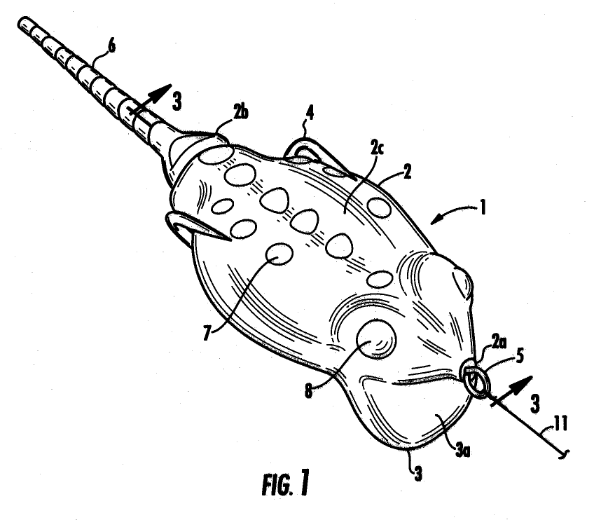

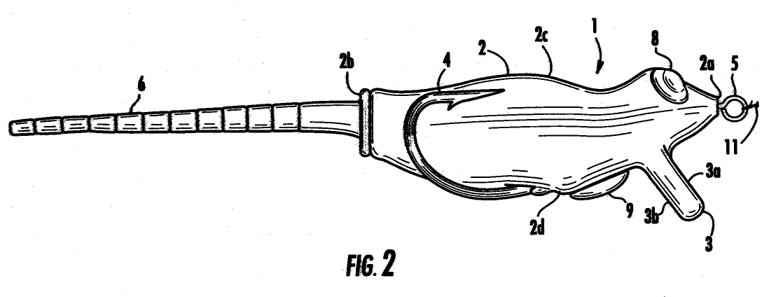

Referring generally to FIGS. 1-3, the present invention includes a fishing lure 1 which includes a body 2 and a lip 3. The fishing lure 1 is constructed with a soft polymer or a combination thereof including a variety of vinyl resins and plastisols, such as, for example, polyvinyl chloride (PVC), dioctyl phthalate (DOP), napthenic oil, elastomeric polymer emulsion (EPE), substantially rigid plastics, any combination thereof and/or any other resin or plastisol. The texture of the materials used to construct the fishing lure 1 can be varied depending on the particular bait characteristics of the target fish.

The lure body 2 may have one or more sidewalls enclosing a hollow interior portion 12. The sidewalls of the lure body 2 may be of any thickness, shape or color, and may include fish attracting elements 7, such as reflectors; materials with various colors; colored, embossed, or raised design elements; or other elements that may be used to attract fish, including light or sound emitting elements. Air or another gas is disposed in the hollow interior portion 12 of the lure body 2, giving the lure body buoyancy. Other properties of the lure body 2 may include flexibility, resiliency, rigidness, deformability, and the like. The lure body 2 is configured and structured to engage or hold a hook, connector (such as a swivel or wire loop) 5 for connecting the lure to a fishing line 11, a weight 9, or other fish attracting elements, such as a movable tail 6 or other appendages commonly associated with frogs, fish, salamanders, squid, shrimp, crabs, small rodents, birds or other mammals, such as legs, fins, claws, tentacles, wings, etc.

The lure body 2 may have various shapes and configurations. As shown in the illustrated embodiments, the lure body 2 is shaped like a frog. However, it should be understood that any other shape or configuration may be employed so as to emulate any living creature, such as a worm, grub, snake, eel, fish, salamander, squid, shrimp, crab, small rodent, bird or other mammal. Further, as noted above, the lure body 2 may be designed and formed to provide relative movement to the lure parts or appendages (e.g., a movable tail 6) as the lure is drawn through the water. The lure body 2 has a front end 2a and back end 2b, where the lure faces the front end. The lure body 2 preferably is aligned along a longitudinal axis and has a top side 2c and bottom side 2d, where the top side of the lure body faces in a generally upwards direction during retrieval of the lure and the bottom side of the lure body faces a generally downwards direction during retrieval.

The lip 3 of the fishing lure is connected to the lure body 2. The lip 3 and the lure body 2 may be two separate members mechanically attached together or, more preferably, one integral member attached together by, for example, a chemical bond. The lip 3 is configured to extend from the front end 2a and/or the bottom side 2d of the lure body 2. The lip 3 has an upper surface 3a and an underside 3b. The upper surface 3a of the lip 3 may extend forwardly towards the front end 2a of the lure body 2 such that the angle between the lip and the longitudinal axis of the lure body is equal to or less than about 90 degrees.

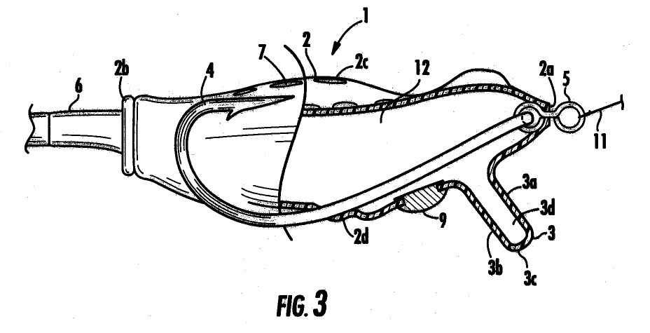

As illustrated in FIG. 3, the lip has a sidewall 3c defining and surrounding a hollow interior cavity 3d. The hollow interior cavity 3d of the lip 3 may be integral with the hollow interior cavity 12 of the lure body 2 so that the lure body and the lip define a single hollow interior cavity, as shown in FIG. 3. The hollow interior cavity 3d of the lip 3 may be occupied by air or another gas so as to create a light weight lure 1 and to increase the buoyancy of the lure.

The lip 3 may take on any dimension so as to allow the lure to dive relative to the surface of the water during moderate to high retrieval speeds. In one preferred embodiment, the lip 3 is structured so that the lure 1 will dive approximately one to two inches below the surface of the water when the lure is retrieved at slow to moderate retrieval speeds (e.g., at about 12 inches per second to about 30 inches per second) and approximately one to two feet below the surface of the water when the lure is retrieved higher retrieval speeds (e.g., at about 30 inches per second to about 60 inches per second). For example, the width of the lip 3, measured between the sides of the lip, may be approximately 0.25 inches to approximately 2 inches. The length of the lip 3, measured from where the lip meets the lure body 2 and the tip of the lip, may vary depending on the desired depth to be obtained when retrieving at higher retrieval speeds (i.e. the desired resistance to be created when the lure is pulled through the water). For example, in one embodiment, the length of the lip 3 may vary from 0.1 inches up to one inch or more. The thickness of the lip 3, measured between the upper side 3a and the underside 3b of the lip, may be any thickness, such as, for example, any thickness between 0.1 inches up to 0.5 inches. The configuration of the lip 3 may be any shape so as to resemble any part of a living creature, including a mouth, lip, appendage, fin, and the like.

The material used to construct the lip 3 is a flexible, resilient material. The material may be the same material used to construct the lure body 2 and may include reflecting elements; materials with various colors; colored, embossed, or raised design elements; or other elements that may be used to attract fish, including light or sound emitting elements. A combination of materials and elements may be employed to construct the lip 3 so as to achieve a desired appearance, sound, or movement.

As illustrated in FIG. 1, the lure 1 includes a pair of conventional hooks 4 attached to the lure body 2. However, it should be understood that any amount and type of fish hook may be attached to the lure body 2 and/or the lip 3. Additionally, one of ordinary skill in the art would appreciate the wide number of items that may be attached to the lure body 2 including hooks 4, connectors 5 (such as swivels or wire loops) for connecting the lure 1 to a fishing line 11, weights 9, appendages, reflecting members, decorative items, and/or other fish attracting elements (such as a movable tail 6 or other appendage, as discussed above). Preferably, as illustrated in FIG. 3, the hook(s) 4 are at least partially concealed in that a portion of the hook is concealed within the hollow interior cavity 12 of the lure body 2 while the remainder of the hook protrudes from the lure body in such a manner as to remain in close proximity to the sides of the lure body and not protrude above the top side 2c or below the bottom side 2d of the lure body. Advantageously, this minimizes the possibility of the hooks becoming snagged or hung-up on any obstacle, such as floating vegetation, brush, or fallen timber, while allowing the hook(s) to be exposed in the event a fish bites down on the flexible and hollow lure body.

The present invention also provides a method of forming or constructing the fishing lure 1 of the present invention. In one embodiment, the lure is constructed from a dip molding process. More specifically, a mandrel or mold may be preformed to duplicate the internal core of the fishing lure that will be produced. For example, the mandrel may be shaped to resemble the internal core of any living creature, including a frog, worm, grub, snake, eel, fish, salamander, squid, shrimp, crab, small rodent, bird or other mammal, or any other shape for attracting fish. The mandrel has a protuberance extending therefrom having the desired dimensions of the hollow interior cavity 3d of the lip 3. The mandrel is typically constructed of a high grade of aluminum, but may be constructed of any other material capable of transferring thermal energy. In one embodiment, a plurality of mandrels may be formed and attached to a rack so that multiple fishing lures 1 may be made simultaneously.

Once the mandrel is formed, the mandrel may be coated with a lubricant, such as a silicon oil, and thermal energy or heat is transferred to the mandrel. The thermal energy or heat may be applied by conduction, convection, or radiation. The amount of heat applied may vary. In one embodiment, the heat applied to the mandrel is between approximately 475° F. to 500° F. In one embodiment, the mandrel is heated to at least 320° F. and, more preferably, to between about 380° F. to about 400° F.

Once the mandrel is heated to the desired temperature, the mandrel is immersed into a liquid solution, including compounds such as, for example, polyvinyl chloride (PVC), dioctyl phthalate (DOP), napthenic oil, elastomeric polymer emulsion (EPE), any combination thereof and/or any resin or plastisol. The liquid solution or compound may be pre-colored for the desired lure being produced. While the heated mandrel is immersed in the liquid solution, the heat of the mandrel is transferred into the liquid solution, catalyzing the liquid solution into an elastic solid that adheres to and encapsulates at least a portion of the mandrel. The greater the amount of time that the mandrel is immersed, the greater the thickness of elastic material that builds up to form the fishing lure. One of ordinary skill in the art will recognize that if the temperature of the mandrel is less than the temperature needed for catalyzation, material build up on the mandrel may cease. After achieving the desired thickness of the fishing lure 1, the mandrel with the fishing lure adhered thereto is removed from the liquid solution. Optionally, at the beginning of the immersion process, a timer may be activated after a set period of time to generate an alert for an operator to remove the mandrel from the liquid solution.

In one embodiment, after removal from the liquid solution, additional decoration, such as eyes, pupils, and the like, may be added to the fishing lure 1. For most lures 1, the additional decoration may be applied by dabbing a thicker paste of the liquid solution at the desired location on the fishing lure. If the temperature of the mandrel is less than the catalyzation temperature, thermal energy or heat is applied to the additional decoration and/or the fishing lure 1. Thermal energy or heat may be applied to the additional decoration via an oven or other heat delivery system via conduction, convection or radiation in order to cure via catalyzation the additional decoration to the fishing lure.

Once the catalyzation process is complete, the fishing lure 1 is then cooled by any cooling means, such as a water bath. One or more holes may be cut into the fishing lure 1 by an electrically heated tool, as desired. At least one of the holes may be employed to remove the fishing lure 1 from the mandrel. The resulting fishing lure 1 has the hollow body 2 and hollow lip 3.

To complete the bait, various other items may be attached to the fishing lure as would be understood by one of ordinary skill in the art. For example, fish hooks 4, weights 9, bait appendages (such as a movable tail 6), and fish attracting elements, as desired, may be added to the fishing lure.

In another embodiment, the lure may be constructed via a rotational molding process. More specifically, a mold is formed so that the interior surface of the mold duplicates the outer surface the fishing lure that will be produced, including defining a recess having the desired external dimensions of the lip 3. For example, the internal surface of the mold may be shaped to resemble the outer surface of any living creature, including a frog, worm, grub, snake, eel, fish, salamander, squid, shrimp, crab, small rodent, bird or other mammal, or any other shape for attracting fish. The mold is typically manufactured from stainless steel, fabricated steel, cast aluminum or fabricated aluminum. In one embodiment, a plurality of molds may be employed to simultaneously create a plurality of fishing lures 1.

After the mold has been formed, a pre-measured amount of a polymeric material, typically in powder, pellet or other solid form, is inserted or loaded into the mold. A variety of polymeric or resin materials may be employed, such as elastomeric materials, polyethylene, plastisols, polycarbonate, nylon, polypropylene or any other polymer or resin as would be known to one skilled in the art.

Once the polymeric material is loaded into the mold, the mold is closed and the mold is then rotated and heated. The mold is rotated in at least one axis. In one embodiment, the mold is rotated, either simultaneously or sequentially, about two axis or bi-axially, such as rotating about an x-axis and a y-axis. In one embodiment, the rotation is slow so that there are no centrifugal forces applied to the polymeric material located therein. During rotation, the molds are delivered thermal energy or heat by conduction, convection and/or radiation. For example, the molds may be heated by an oven, a flame applied to the mold, and/or electrical heating coils. Typically, temperatures to heat the mold range from about 400° F. to about 500° F. The resulting transfer of thermal energy or heat causes the polymeric materials to liquefy within the mold. When the mold is rotated, the liquefied polymeric material circulates around the internal surface of the mold and adheres thereto. After a predetermined time or amount of mold rotations, the internal surface of the walls of the mold are coated with a predetermined thickness of plastic or other elastomeric or polymeric material, forming the sidewalls of the fishing lure, including the hollow lip 3.

The mold and the formed fishing lure 1 are then cooled by, for example, a water bath, water spray or by ambient conditions. After cooling the mold and the fishing lure 1, the mold may be opened and the fishing lure, having a hollow body and hollow lip, is then removed from the mold. Then, decorative additions may be attached to the fishing lure as well as fish hooks 4, weights 9, bait appendages (such as the movable tail 6), and other fish attracting elements, as desired.

Operation of the fishing lure 1 will now be described. A fisherman or angler casts the lure 1 of the present invention. Typically, the angler attempts to cast the lure near shore or adjacent other structures that are partially submerged and partially exposed (such as tree limbs, vegetation, brush or floating debris). The weight 9 attached to the lure body 2 provides castability (i.e., distance and directional control) to the lure 1. The angler may allow the lure 1 to sit as a surface lure for a moment during which time the buoyancy of the lure causes the lure to remain mostly afloat on the surface of the water. The fisherman can vary his retrieve style and impart several actions to the lure on the water surface, as known to those of ordinary skill in the art, such as “walk the dog” (i.e., creating action where the lure moves from side-to-side when slowly reeled in), “chugger style” (i.e., creating a loud “chug” or squirt of water when the lure is twitched or jerked), “dead stick” (i.e., resting the lure on the surface of the water and periodically giving a jerk) or any other style where the fisherman casts the lure out and applies no action or very little action to the lure.

The angler may then begin to retrieve the lure 1 steadily using a slow to moderate retrieval speed. When retrieved gradually or intermittently, the fishing lure will remain afloat on the surface of the water, which may be preferred to avoid becoming snagged or hung-up on submerged obstacles, such as fallen timber. The fishing lure 1 of the present invention is also able to function as a wake bait (i.e., submerged just under the surface of the water) when retrieved at slightly increased, but yet still relatively slow speeds to thereby create a large bulging wake (i.e., a wake effect) imitating the motion of a small mammal swimming on the surface. Because the upper surface of the lip has a downward angle relative to the lure body, the movement of the upper surface 3a of the lip 3 through the water initially asserts a downward force on the lure due to the drag created by the lip, allowing the lure to dive downwardly into and under the water surface. The depth that the lure dives to is proportional to the retrieval rate of the lure. For example, a slow to medium speed of retrieval (e.g., at about 12 inches per second to about 30 inches per second)) the lure acts as a wake bait by diving to a relatively shallow depth just under the surface of the water (e.g. approximately 1-2 inches under the surface of the water), which creates a large bulging wake. When the lure 1 is retrieved higher retrieval speeds (e.g., at about 30 inches per second to about 60 inches per second), the lure to act as a crankbait by diving to a greater depth (e.g. approximately 1-2 feet or more under the surface of the water). In addition to retrieval rate, rod tip height above water also affects the minimum and maximum speeds for creating a wake effect. The higher the rod tip is above the water the faster the lure can be retrieved without it diving, alternately the closer the rod tip is to the water the slower the lure must be retrieved to prevent it from diving. However, it has been found that the approximate upper limit on the retrieval rate was about 30 inches per second with the rod tip up (i.e., positioned between where the axis of the fishing rod is parallel to the surface of the water and where the axis is perpendicular to the surface of the water with the butt of the rod pointing toward the surface of the water) to create a wake effect. The high buoyancy to weight ratio of the fishing lures 1 of the present invention also enable the lures of the present invention to provide life-like motion common to living creatures, such as a land mammal, animal or an amphibian, whether on and below the surface of the water.

The present invention has several advantages. The fishing lure 1 of the present invention can be configured to emulate many common live-bait species and can be weighted to provide castability. More importantly though, the lure 1 is versatile due to its ability to effectively function as a “surface lure”, a “wake bait”, and a “crankbait” in a single cast. More specifically, the fishing lure of the present invention is able to function as a surface lure immediately after the cast (i.e., floating on the surface of the water), which is typically near shore or adjacent other structures that are partially submerged and partially exposed (such as tree limbs, vegetation, brush or floating debris), which minimizes the possibility the lure will become snagged or hung-up. Specifically, the lure body 2 and the lure lip 3 are flexible so that when the lure encounters an obstacle, such as floating vegetation, brush, or fallen timber, the lure flexes rearwardly so that the lure may continue unimpeded. The fishing lure 1 of the present invention is able to function as a wake bait (i.e., submerged just under the surface of the water) when retrieved at slower speeds to thereby create a large bulging wake imitating the motion of a small mammal swimming on the surface. The fishing lure 1 of the present invention is also able to function as a crankbait during moderate to high retrieval of the lure (i.e., diving under the surface of the water) so that the lure can be placed in the strike zone of a fish during retrieval in deeper water. The high buoyancy to weight ratio of the fishing lures 1 of the present invention also enable the lures of the present invention to provide life-like motion whether on and below the surface of the water. The functionality of the lure results from the lip 3 and lure body 3 being hollow, which provides for a reduction in weight, a higher buoyancy, more level flotation, and high castability.

The flexibility of the lip 3 also allows the lure to remain in one area longer when the angler snaps the rod than a conventional surface lure having a solid lip. In this regard, the lip 3 of the present invention has improved flexibility so that the lip initially deforms rearwardly in response to the force of the water thereby lessening the flow of water over the surface of the lip relative to a conventional solid lip. Thereafter, as the water begins to flow over the surface of the lip 3, the lip springs back into place due to the elasticity of the lip. This movement of the lip 3 thrusts water forward, restricting the typical forward motion commonly associated with lures having solid lips.

The method of constructing the fishing lure 1 of the present invention also has several advantages. In particular, the fishing lure 1 is cost effective because less material is required to construct the lure and the method forms an integral lure without requiring additional adhesives or fasteners.

Specific embodiments of the invention are described herein. Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

That which is claimed:

1. A fishing lure, comprising:
a body having a front end and a back end, said body defining an interior hollow body portion; and
a lip extending from said front end of said body and having at least one sidewall that defines an interior hollow lip portion.

2. The fishing lure according to claim 1 further comprising at least one fish hook and wherein said at least one fish hook extends at least partially through said body.

3. The fishing lure according to claim 2 wherein said at least one fish hook comprises two fish hooks.

4. The fishing lure according to claim 1 wherein said interior hollow body portion is connected with said interior hollow lip portion so as to create a unitary hollow cavity between said lip and said body.

5. The fishing lure according to claim 1 wherein said lip is formed integrally with said body.

6. The fishing lure according to claim 1 wherein said body has a top side and a bottom side, and wherein said lip extends from said body from said bottom side of said body.

7. The fishing lure according to claim 1 wherein said lip comprises an upper surface that extends forwardly toward said front end of said body.

8. The fishing lure according to claim 1 wherein said body has a configuration from the group consisting of frog, worm, grub, snake, eel, fish, salamander, squid, shrimp, crab, small rodent, bird or other mammal.

9. The fishing lure according to claim 1 wherein said body comprises at least a portion comprised of an elastomeric material.

10. The fishing lure according to claim 1 further comprising at least one weight.

11. The fishing lure according to claim 1 wherein said body comprises at least one fish attracting element.

12. The fishing lure according to claim 1 further comprising a movable appendage attached to said body.

13. A method for forming a fishing lure, comprising:
forming a fishing lure using rotational molding,
wherein the fishing lure comprises:
a body having a front end and a rear end and at least one sidewall that defines an interior hollow body portion; and
a lip extending from the front end of the body and having at least one sidewall that defines an interior hollow lip portion.

14. The method according to claim 13 wherein said forming step comprises:
inserting at least one polymeric material into a mold;
rotating the mold about at least one axis so that the polymeric material is allowed to coat at least a portion of an interior surface of the mold so as to form a sidewall of the fishing lure; and
removing the fishing lure from the mold.

15. The method according to claim 14 further comprising providing the mold having a configuration so that the lip is formed to extend forwardly toward the front end of the body.

16. The method according to claim 15 wherein said rotating step comprises rotating the mold about two axes.

17. The method according to claim 14 further comprising:
prior to, or simultaneously with, said rotating step, heating the mold so that the at least one polymeric material is allowed to absorb thermal energy and adhere to the sidewall of the mold; and
after said rotating step, cooling the mold.

18. The method according to claim 14 further comprising:
prior to said inserting step, providing the at least one polymeric material, wherein the at least one polymeric material is in solid form.

19. The method according to claim 14 wherein said heating step comprises heating by one of a group consisting of conduction, convection, and radiation.

20. The method according to claim 14 further comprising inserting at least one fish attracting element into the mold.

21. The method according to claim 14 further comprising attaching at least one fish hook to the body of the fishing lure.

22. The method according to claim 13 wherein said forming step comprises forming said fishing lure in a configuration from a group consisting of a frog, worm, grub, snake, eel, fish, salamander, squid, shrimp, crab, small rodent, bird or other mammal.

23. A method for forming a fishing lure, comprising:
forming a fishing lure using dip molding,
wherein the fishing lure comprises:
a body having a front end and a rear end and at least one sidewall that defines an interior hollow body portion; and
a lip extending from the front end of the body and having at least one sidewall that defines an interior hollow lip portion.

24. The method according to claim 23 further comprising attaching at least one fish hook to the body of the fishing lure.

25. The method according to claim 23 wherein said forming step comprises:
providing a mandrel;
contacting at least a portion of the mandrel to at least one plastisol for a predetermined time period to form the fishing lure; and
removing the fishing lure from the mandrel.

26. The method according to claim 25 further comprising:
prior to said contacting step, applying at least one lubricant to the mandrel.

27. The method according to claim 25 further comprising:
prior to said contacting step, applying thermal energy to the mandrel.

28. The method according to claim 27 wherein said applying thermal energy comprises heating the mandrel to at least 320° F.

29. The method according to claim 27 further comprising:
after said contacting step, cooling the fishing lure disposed on the mandrel.

30. The method according to claim 25 further comprising:
after said contacting step, applying decorative plastisol to the fishing lure; and
applying thermal energy to the decorative plastisol so that the decorative plastisol cures to the fishing lure.

31. The method according to claim 25 wherein said providing a mandrel comprises providing a mandrel configured so that the lip is formed to extend forwardly toward the front end of the body.

32. The method according to claim 23 wherein the mandrel comprises a body to form the fishing lure body in a configuration from a group consisting of a frog, worm, grub, snake, eel, fish, salamander, squid, shrimp, crab, small rodent, bird or other mammal, and wherein the mandrel comprises a lip portion to create the interior hollow lip portion of the fishing lure lip.
